(19) United States
(12) Patent Application Publication
(10) Pub. No.: US 2017/0297285 A1
(43) Pub. Date: Oct. 19, 2017

(54) BEAD CORE COVERING METHOD AND BEAD CORE COVERING DEVICE

(71) Applicant: TOYO TIRE & RUBBER CO., LTD., Osaka (JP)

(72) Inventors: Yoshiki Hashimoto, Osaka-shi (JP); Ryoshi Miyamoto, Osaka-shi (JP); Masayoshi Abe, Osaka-shi (JP)

(73) Assignee: TOYO TIRE & RUBBER CO., LTD., Osaka (JP)

(21) Appl. No.: 15/475,692

(22) Filed: Mar. 31, 2017

(30) Foreign Application Priority Data
Apr. 19, 2016 (JP) 2016-083880
Aug. 10, 2016 (JP) 2016-157592

(51) Int. Cl. B29D 30/50

(52) U.S. Cl. CPC B29D 30/50

(57) ABSTRACT

A bead core covering method for covering an annular bead core with a belt-like rubber sheet includes winding the rubber sheet extruded by an extruding machine via a mouth piece around an outer peripheral surface of a rotary drum from a leading end portion, attaching a part in a width direction of the rubber sheet on the outer peripheral surface of the rotary drum to an outer surface of the bead core, which rotates, from the leading end portion before the rubber sheet is wound over an entire periphery of the outer peripheral surface of the rotary drum, and wrapping a remaining portion in the width direction of the rubber sheet attached to the outer surface of the bead core along a cross-sectional shape of the bead core.

### BACKGROUND OF THE INVENTION

### Field of the Invention

The present invention relates to a bead core covering method and a bead covering device for covering an annular bead core with a belt-like rubber sheet.

### Description of the Related Art

Generally, an annular bead core formed by covering with rubber a convergence body such as a steel wire is arranged in a bead portion of a pneumatic tire. In some cases, a surface of the bead core is covered with a thin rubber sheet for integrating the steel wire and the like. The rubber sheet may be called as a cover rubber or a bead cover rubber.

The following Patent Document 1 describes a bead core covering device and a bead core covering method for covering a surface of a bead core with a sheet member made of a rubber. The bead core covering device of Patent Document 1 is provided with a supply portion which supplies to a rotating bead core a belt-like sheet member covering a surface of the bead core, a shaping roller which rotates along a rotating direction of the bead core, surrounds the sheet member supplied from the supply portion from a width direction, and attaching a part of the sheet member to the bead core while shaping along a cross sectional shape of the bead core, and a pressing roller which is arranged on a downstream side in the rotating direction of the bead core than the shaping roller, comes into contact with the sheet member attached to the surface of the bead core, and rotates in a direction of an end portion of the sheet member from the contact position.

A bobbin is arranged in the supply portion for supplying the sheet member, the bobbin to which the sheet member formed into a long thin-band shape with a predetermined width is laminated in advance. In a method of supplying the sheet member stocked in the bobbin to the bead core as mentioned above, a process for winding the sheet member around the bobbin in advance is necessary. Further, since it is necessary to arrange a film between the sheet members so as to prevent the sheet members laminated to the bobbin from being bonded to each other, a cost is increased. Further, in the case that the sheet member is attached to the bead core, a process for peeling off the film is necessary, and a man hour for work is increased. When the film is peeled off, a tension is applied to the sheet member and a dimensional change is caused.

Further, the following Patent Document 2 describes a method of wrapping a cover rubber around a bead core and a device thereof. The device of Patent Document 2 is provided with a let-off device for supplying the cover rubber, a festooner to which the cover rubber getting out of the let-off device is fed in, and a bead covering device which covers the bead core with the cover rubber. The festooner is structured such as to absorb a speed difference of the cover rubber between the let-off device and the bead covering device. However, when such a festooner is employed, a dimensional change is caused by application of tensional force to the cover rubber, and a precision is deteriorated.

Further, in the case that the sheet member is wrapped up to the outer peripheral surface side from the inner peripheral surface side along the cross-sectional shape of the bead core as described in Patent Document 1, the rate of tension is enlarged toward the outer peripheral surface side and the thickness of the sheet member gradually becomes thin, since the peripheral length of the outer peripheral surface of the bead core is longer than the peripheral length of the inner peripheral surface. As a result, there is a concern that the length of the sheet member becomes short on the outer peripheral surface side and the sheet member is broken by the tension. Further, since the sheet member is wrapped up by applying the tension from the inner peripheral surface side to the outer peripheral surface side, a camber back of the sheet member occurs in the middle of the wrapping, thereby causing wrinkles.

Meanwhile, in the case that the cover rubber is wrapped up from the outer peripheral surface side to the inner peripheral surface side along the cross-sectional shape of the bead core as described in Patent Document 2, the cover rubber remains in the inner peripheral surface side and there is a concern that the wrinkles are generated, since the peripheral length of the inner peripheral surface of the bead core is shorter than the peripheral length of the outer peripheral surface.

### PRIOR ART DOCUMENTS

### Patent Documents

Patent Document 1: JP-A-2012-240334

Patent Document 2: JP-A-49-15778

### SUMMARY OF THE INVENTION

Accordingly, an object of the present invention is to provide a bead core covering method and a bead core covering device which can cover a bead core at high precision with a belt-like rubber sheet while suppressing a cost and a man hour for work.

The object can be achieved by the following present invention. That is, the present invention provides a bead core covering method for covering an annular bead core with a belt-like rubber sheet, the method comprising the steps of winding the rubber sheet extruded by an extruding machine via a mouth piece around an outer peripheral surface of a rotary drum from a leading end portion, attaching a part in a width direction of the rubber sheet on the outer peripheral surface of the rotary drum to an outer surface of the bead core, which rotates, from the leading end portion before the rubber sheet is wound over an entire periphery of the outer peripheral surface of the rotary drum; and wrapping a remaining portion in the width direction of the rubber sheet attached to the outer surface of the bead core along a cross-sectional shape of the bead core.

According to the bead core covering method based on the structure mentioned above, the belt-like rubber sheet extruded out of the extruding machine is wound around the outer peripheral surface of the rotary drum from the leading end portion, the part in the width direction of the rubber sheet wound around the outer peripheral surface of the rotary drum is then attached to the outer surface of the bead core from the leading end portion, and the remaining portion in the width direction of the rubber sheet is finally wrapped along the cross-sectional shape of the bead core. More specifically, the rubber sheet extruded out of the extruding machine is structured such as to be directly attached to the outer surface of the bead core via the rotary drum. According to the structure mentioned above, the stock by the bobbin which is used in the method of Patent Document 1 is not necessary, and it is possible to suppress the cost and the man hour for work.

Further, in the conventional method, a precision of the cover rubber is deteriorated due to a tension at a time of winding around the bobbin, a tension at a time of peeling off the film, a tension at a time of conveying by the festooner, and a dimensional change caused by constriction in a convey line. However, according to the present invention, since the rubber sheet extruded out of the extruding machine is attached to the outer surface of the bead core after being temporarily wound around the outer peripheral surface of the rotary drum, it is possible to cover the bead core with the rubber sheet at high precision while preventing the dimensional change. Further, since the rubber sheet is wound around the bead core just after being extruded out of the extruding machine, it is possible to improve an adhesion defect to the bead core without being affected by a tackiness reduction caused by deterioration with age.

In the step of winding the rubber sheet around the outer peripheral surface of the rotary drum from the leading end portion, the distance from the outer peripheral surface of the rotary drum to the mouth piece may be set to be equal to or less than a desired thickness of the rubber sheet.

According to the structure, since the thickness of the rubber sheet can be controlled by the gap between the mouth piece and the outer peripheral surface of the rotary drum, the rubber sheet can be extruded with high precision.

Further, in the step of attaching the part in the width direction of the rubber sheet on the outer peripheral surface of the rotary drum to the outer surface of the rotating bead core from the leading end portion, a retaining roller may be arranged at a position which faces to the rotary drum with a part of the bead core interposed between the retaining roller and the rotary drum, and the rubber sheet may be attached while pressing the bead core by the retaining roller.

According to the structure mentioned above, the rubber sheet can be pressed to the bead core, and the bead core can be covered with the rubber sheet at high precision.

Further, the present invention provides A bead core covering device for covering an annular bead core with a belt-like rubber sheet, the device comprising an extruding machine which extrudes the rubber sheet, a rotary drum around which the rubber sheet extruded from the extruding machine is wound, a wrapping device which supports the bead core at a position closer to a downstream side in a rotating direction of the rotary drum than the extruding machine such that an outer peripheral surface of the rotary drum and an outer surface of the bead core come close to each other, and rotates the supported bead core, and a controller which controls the extruding machine, the rotary drum and the wrapping device, wherein the controller winds the rubber sheet extruded out of the extruding machine around the outer peripheral surface of the rotary drum from a leading end portion, attaches a part in a width direction of the rubber sheet on the outer peripheral surface of the rotary drum to the outer surface of the bead core, which rotates, from the leading end portion before the rubber sheet is wound over an entire periphery of the outer peripheral surface of the rotary drum, and wraps a remaining portion in the width direction of the rubber sheet attached to the outer surface of the bead core along a cross-sectional shape of the bead core by the wrapping device.

According to the bead core covering device based on the structure mentioned above, the belt-like rubber sheet extruded out of the extruding machine is wound around the outer peripheral surface of the rotary drum from the leading end portion, the part in the width direction of the rubber sheet wound around the outer peripheral surface of the rotary drum is then attached to the outer surface of the bead core from the leading end portion, and the remaining portion in the width direction of the rubber sheet is finally wrapped along the cross-sectional shape of the bead core. More specifically, the rubber sheet extruded out of the extruding machine is structured such as to be directly attached to the outer surface of the bead core via the rotary drum. According to the structure mentioned above, the stock by the bobbin which is used in the method of Patent Document 1 is not necessary, and it is possible to suppress the cost and the man hour for work.

Further, in the conventional method, a precision of the cover rubber is deteriorated due to a tension at a time of winding around the bobbin, a tension at a time of peeling off the film, a tension at a time of conveying by the festooner, and a dimensional change caused by constriction in a convey line. However, according to the present invention, since the rubber sheet extruded out of the extruding machine is attached to the outer surface of the bead core after being temporarily wound around the outer peripheral surface of the rotary drum, it is possible to cover the bead core with the rubber sheet at high precision while preventing the dimensional change. Further, since the rubber sheet is wound around the bead core just after being extruded out of the extruding machine, it is possible to improve an adhesion defect to the bead core without being affected by a tackiness reduction caused by deterioration with age.

In the bead core covering device according to the present invention, it is preferable that an outer diameter of the rotary drum is smaller than an inner diameter of the bead core, and the rotary drum is arranged on an inner peripheral side of the bead core which is supported by the wrapping device.

According to this structure, the entire deice can be made compact.

In the bead core covering device according to the present invention, the rotary drum is preferably provided with a cooling mechanism which cools the outer peripheral surface.

In the case that the rubber sheet extruded out of the extruding machine is repeatedly wound around the rotary drum, a temperature of the outer peripheral surface of the rotary drum rises up too much and the rubber sheet is attached to the outer peripheral surface, so that there is a possibility that it is hard to peel off the rubber sheet on the outer peripheral surface to attach it to the bead core. The temperature rise on the outer peripheral surface of the rotary drum can be suppressed by cooling the outer peripheral surface of the rotary drum by the cooling mechanism.

The object can be achieved by the following present invention. That is, the present invention provides a bead core covering method for covering an annular bead core with a belt-like rubber sheet, the method comprising the steps of attaching a leading end portion of the rubber sheet extruded by an extruding machine via a mouth piece to a groove bottom surface and groove wall surfaces of a peripheral groove which is formed along a peripheral direction in an outer surface of a rotary drum, and winding the rubber sheet around the rotary drum, attaching the leading end portion of a portion which is positioned in the groove bottom surface of the peripheral groove in the rubber sheet on the outer surface of the rotary drum to an inner peripheral surface of the rotating bead core before the rubber sheet is wound around a whole periphery of the outer surface of the rotary drum, and winding the rubber sheet around the inner peripheral surface of the bead core, and wrapping up a remaining portion in a width direction of the rubber sheet wound around the inner peripheral surface of the bead core along a cross-sectional shape of the bead core.

According to the bead core covering method based on the structure mentioned above, the belt-like rubber sheet extruded out of the extruding machine is wound around the peripheral groove of the rotary drum from the leading end portion, the rubber sheet wound around the outer peripheral surface of the rotary drum is then wound around the inner peripheral surface of the bead core from the leading end portion, and the remaining portion in the width direction of the rubber sheet is finally wrapped along the cross-sectional shape of the bead core. More specifically, the rubber sheet extruded out of the extruding machine is structured such as to be directly attached to the outer surface of the bead core via the rotary drum. According to the structure mentioned above, the stock by the bobbin which is used in the method of Patent Document 1 is not necessary, and it is possible to suppress the cost and the man hour for work.

Further, in the conventional method, a precision of the cover rubber is deteriorated due to a tension at a time of winding around the bobbin, a tension at a time of peeling off the film, a tension at a time of conveying by the festooner, and a dimensional change caused by constriction in a convey line. However, according to the present invention, since the rubber sheet extruded out of the extruding machine is attached to the outer surface of the bead core after being temporarily wound around the outer peripheral surface of the rotary drum, it is possible to cover the bead core with the rubber sheet at high precision while preventing the dimensional change. Further, since the rubber sheet is wound around the bead core just after being extruded out of the extruding machine, it is possible to improve an adhesion defect to the bead core without being affected by a tackiness reduction caused by deterioration with age.

Further, since the rubber sheet extruded out of the extruding machine is wound around the groove bottom surface and the groove wall surface of the peripheral groove of the rotary drum, the peripheral length of the portion which is wound around the groove wall surface becomes longer than the peripheral length of the portion which is wound around the groove bottom surface. As a result, in the case that the rubber sheet is wrapped up to the outer peripheral surface side from the inner peripheral surface side along the cross-sectional shape of the bead core, it is possible to suppress the tension which is generated on the outer peripheral surface side of the bead core, and to wrap up the rubber sheet with an even thickness and at high precision.

Further, the present invention provides a bead core covering method for covering an annular bead core with a belt-like rubber sheet, the method comprising the steps of attaching a leading end portion of the rubber sheet extruded by an extruding machine via a mouth piece to a top surface and side surfaces of a peripheral projection which is formed along a peripheral direction in an outer surface of a rotary drum, and winding the rubber sheet around the rotary drum, attaching the leading end portion of a portion which is positioned in the top surface of the peripheral projection in the rubber sheet on the outer surface of the rotary drum to an outer peripheral surface of the rotating bead core before the rubber sheet is wound around a whole periphery of the outer surface of the rotary drum, and winding the rubber sheet around the outer peripheral surface of the bead core, and wrapping up a remaining portion in a width direction of the rubber sheet wound around the outer peripheral surface of the bead core along a cross-sectional shape of the bead core.

According to the bead core covering method based on the structure mentioned above, the belt-like rubber sheet extruded out of the extruding machine is wound around the peripheral projection of the rotary drum from the leading end portion, the rubber sheet wound around the outer peripheral surface of the rotary drum is then wound around the outer peripheral surface of the bead core from the leading end portion, and the remaining portion in the width direction of the rubber sheet is finally wrapped along the cross-sectional shape of the bead core. More specifically, the rubber sheet extruded out of the extruding machine is structured such as to be directly attached to the outer surface of the bead core via the rotary drum. According to the structure mentioned above, the stock by the bobbin which is used in the method of Patent Document 1 is not necessary, and it is possible to suppress the cost and the man hour for work.

Further, in the conventional method, a precision of the cover rubber is deteriorated due to a tension at a time of winding around the bobbin, a tension at a time of peeling off the film, a tension at a time of conveying by the festooner, and a dimensional change caused by constriction in a convey line. However, according to the present invention, since the rubber sheet extruded out of the extruding machine is attached to the outer surface of the bead core after being temporarily wound around the outer peripheral surface of the rotary drum, it is possible to cover the bead core with the rubber sheet at high precision while preventing the dimensional change. Further, since the rubber sheet is wound around the bead core just after being extruded out of the extruding machine, it is possible to improve an adhesion defect to the bead core without being affected by a tackiness reduction caused by deterioration with age.

Further, the peripheral length of the portion which is wound around the side surface becomes shorter than the peripheral length of the portion which is wound around the top surface, by winding the rubber sheet extruded out of the extruding machine around the top surface and the side surface of the peripheral projection of the rotary drum. As a result, in the case that the rubber sheet is wrapped up to the inner peripheral surface side from the outer peripheral surface side along the cross-sectional shape of the bead core, it is possible to suppress the wrinkles which are generated on the inner peripheral surface side of the bead core, and it is also possible to wrap up the rubber sheet with an even thickness and at high precision.

Further, the present invention provides a bead core covering device for covering an annular bead core with a belt-like rubber sheet, the device comprising an extruding machine which extrudes the rubber sheet, a rotary drum around which the rubber sheet extruded from the extruding machine is wound, a wrapping device which supports the bead core in such a manner that an outer surface of the rotary drum and an inner peripheral surface of the bead core come close to each other at a position on a downstream side in a rotating direction of the rotary drum from the extruding machine, and which rotates the supported bead core, and a controller which controls the extruding machine, the rotary drum and the wrapping device, wherein the outer surface of the rotary drum has a peripheral groove which extends along a peripheral direction, the controller attaches a leading end portion of the rubber sheet extruded by the extruding machine to a groove bottom surface and groove wall surfaces of the peripheral groove in the rotary drum, and winds the rubber sheet around the rotary drum, the controller attaches the leading end portion of a portion which is positioned in the groove bottom surface of the peripheral groove in the rubber sheet on the outer surface of the rotary drum to an inner peripheral surface of the rotating bead core before the rubber sheet is wound around a whole periphery of the outer surface of the rotary drum, and winds the rubber sheet around the inner peripheral surface of the bead core, and the controller wraps up a remaining portion in a width direction of the rubber sheet which is wound around the inner peripheral surface of the bead core along a cross-sectional shape of the bead core by the wrapping device.

The operations and effects of the bead core covering device achieved by such a structure are as mentioned above, and the bead core can be covered with the belt-like rubber sheet at high precision while suppressing the cost and the man hour for work.

In the bead core covering device according to the present invention, it is preferable that a groove depth of the peripheral groove is determined in correspondence to a difference between a diameter of an outer peripheral surface of the bead core and a diameter of the inner peripheral surface of the bead core.

According to the structure mentioned above, it is possible to effectively suppress the tension which is generated in the rubber sheet on the outer peripheral surface side of the bead core in the case that the rubber sheet is wrapped up to the outer peripheral surface side from the inner peripheral surface side along the cross-sectional shape of the bead core.

In the bead core covering device according to the present invention, it is preferable that a leading end of a mouth piece of the extruding machine is formed along a cross-sectional shape of the peripheral groove.

According to the structure mentioned above, the rubber sheet can be extruded at high precision since the thickness of the rubber sheet can be controlled by the gap between the mouth piece and the peripheral groove of the rotary drum.

Further, the present invention provides a bead core covering device for covering an annular bead core with a belt-like rubber sheet, the device comprising an extruding machine which extrudes the rubber sheet, a rotary drum around which the rubber sheet extruded from the extruding machine is wound, a wrapping device which supports the bead core in such a manner that an outer surface of the rotary drum and an outer peripheral surface of the bead core come close to each other at a position on a downstream side in a rotating direction of the rotary drum from the extruding machine, and which rotates the supported bead core, and a controller which controls the extruding machine, the rotary drum and the wrapping device, wherein the outer surface of the rotary drum has a peripheral projection which extends along a peripheral direction, the controller attaches a leading end portion of the rubber sheet extruded by the extruding machine to a top surface and side surfaces of the peripheral projection in the rotary drum, and winds the rubber sheet around the rotary drum, the controller attaches the leading end portion of a portion which is positioned in the top surface of the peripheral projection in the rubber sheet on the outer surface of the rotary drum to an outer peripheral surface of the rotating bead core before the rubber sheet is wound around a whole periphery of the outer surface of the rotary drum, and winds the rubber sheet around the outer peripheral surface of the bead core, and the controller wraps up a remaining portion in a width direction of the rubber sheet which is wound around the outer peripheral surface of the bead core along a cross-sectional shape of the bead core by the wrapping device.

The operations and effects of the bead core covering device achieved by such a structure are as mentioned above, and the bead core can be covered with the belt-like rubber sheet at high precision while suppressing the cost and the man hour for work.

In the bead core covering device according to the present invention, it is preferable that a protruding height of the peripheral projection is determined in correspondence to a difference between a diameter of the outer peripheral surface of the bead core and a diameter of an inner peripheral surface of the bead core.

According to the structure mentioned above, it is possible to effectively suppress the wrinkles which are generated in the rubber sheet on the inner peripheral surface side of the bead core in the case that the rubber sheet is wrapped up to the inner peripheral surface side from the outer peripheral surface side along the cross-sectional shape of the bead core.

In the bead core covering device according to the present invention, it is preferable that a leading end of a mouth piece of the extruding machine is formed along a cross-sectional shape of the peripheral projection.

According to the structure mentioned above, it is possible to extrude the rubber sheet at high precision since the thickness of the rubber sheet can be controlled by the gap between the mouth piece and the peripheral projection of the rotary drum.

### BRIEF DESCRIPTION OF THE DRAWINGS

FIG. 1 is a schematic view showing an example of a structure of a bead core covering device;

FIG. 2 is a schematic view showing an example of a structure of an extruding machine and a rotary drum;

FIG. 3 is a cross-sectional view of a bead core;

FIG. 4A is a cross-sectional view along a line A-A in FIG. 1;

FIG. 4B is a cross-sectional view along a line B-B in FIG. 1;

FIG. 4C is a cross-sectional view along a line C-C in FIG. 1;

FIG. 4D is a cross-sectional view along a line D-D in FIG. 1;

FIG. 4E is a cross-sectional view along a line E-E in FIG. 1;

FIG. 4F is a cross-sectional view along a line F-F in FIG. 1;

FIG. 4G is a cross-sectional view along a line G-G in FIG. 1;

FIG. 4H is a cross-sectional view along a line H-H in FIG. 1;

FIG. 4I is a cross-sectional view along a line I-I in FIG. 1;

FIG. 5 is a schematic view showing another example of the structure of the bead core covering device;

FIG. 6 is a schematic view showing an example of a structure of a bead core covering device;

FIG. 7 is a front elevational view of the rotary drum;

FIG. 8A is a cross-sectional view along a line A-A in FIG. 6;

FIG. 8B is a cross-sectional view along a line B-B in FIG. 6;

FIG. 8C is a cross-sectional view along a line C-C in FIG. 6;

FIG. 8D is a cross-sectional view along a line D-D in FIG. 6;

FIG. 8E is a cross-sectional view along a line E-E in FIG. 6;

FIG. 8F is a cross-sectional view along a line F-F in FIG. 6;

FIG. 8G is a cross-sectional view along a line G-G in FIG. 6;

FIG. 8H is a cross-sectional view along a line H-H in FIG. 6;

FIG. 8I is a cross-sectional view along a line I-I in FIG. 6;

FIG. 9A is a schematic view showing another example of the structure of the bead core covering device;

FIG. 9B is a front elevational view of the rotary drum;

FIG. 10A is across-sectional view of the rotary drum around which a rubber sheet is wound; and

FIG. 10B is across-sectional view of the rotary drum around which the rubber sheet is wound.

### DETAILED DESCRIPTION OF THE PREFERRED EMBODIMENTS

A description will be given below of an embodiment according to the present invention with reference to the drawings. A bead core covering method and a bead core covering device according to the present invention is provided for covering an annular bead core with a belt-like rubber sheet. The bead core according to the present embodiment will be described as a bead core having a hexagonal cross-sectional shape. However, the cross-sectional shape of the bead core which can be covered by the bead core covering method and the bead core covering device according to the present invention is not limited to the hexagonal shape, but may be a quadrangular shape or a round shape.

### First Embodiment

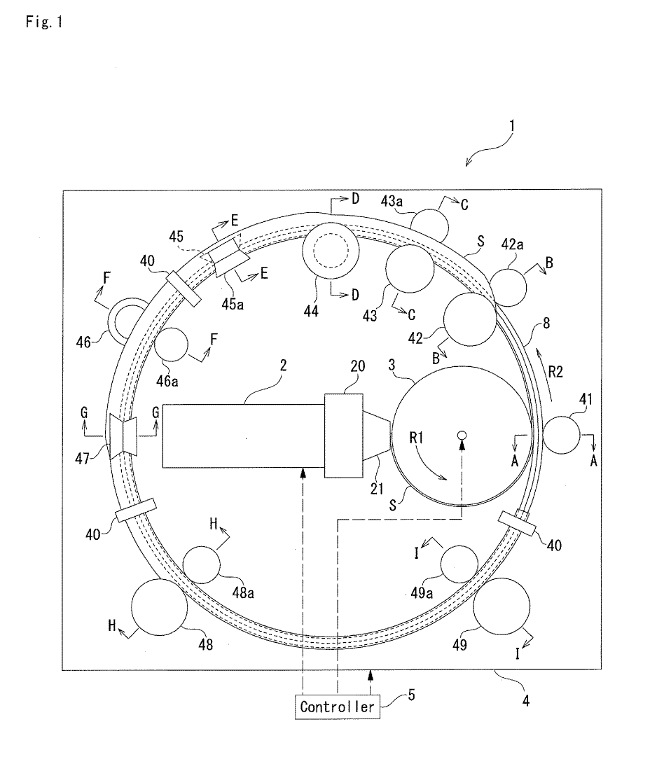

FIG. 1 is a schematic view showing an example of a structure of a bead core covering device 1. The bead core covering device 1 is provided with an extruding machine 2, a rotary drum 3, a wrapping device 4, and a controller 5 which controls the extruding machine 2, the rotary drum 3 and the wrapping device 4.

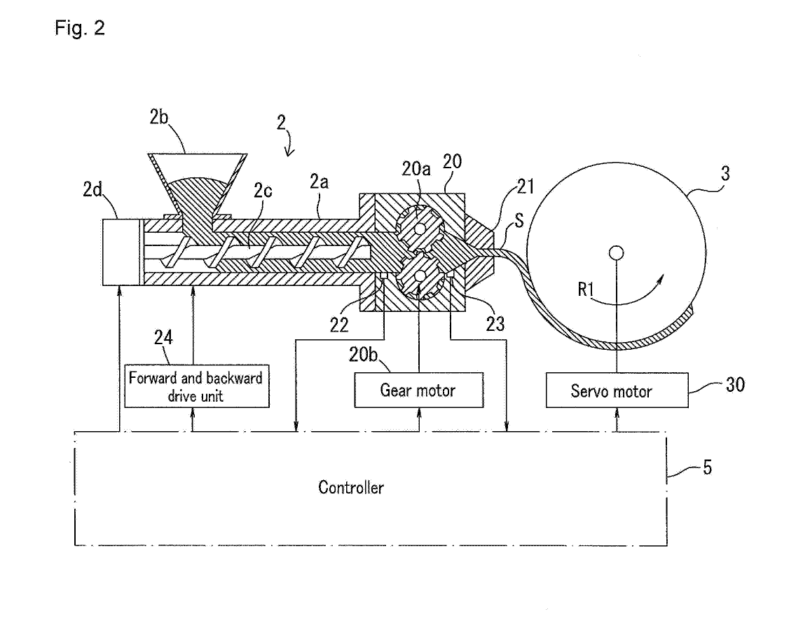

FIG. 2 is a schematic view showing an example of a structure of the extruding machine 2 and the rotary drum 3. The extruding machine 2 has a cylindrical barrel 2a, a hopper 2b which is connected to a supply port of the barrel 2a, a screw 2c which mixes rubber and discharges the rubber to a leading end side, and a screw motor 2d which rotatably drives the screw 2c. The rotating speed of the screw motor 2d is controlled by the controller 5 as mentioned later.

A gear pump 20 is connected to a leading end side in an extruding direction of the extruding machine 2, and a leading end side of the gear pump 20 is connected to a mouth piece 21. A rubber material mixed by the extruding machine 2 is supplied to the gear pump 20, and the gear pump 20 supplies a fixed amount of rubber to the mouth piece 21. A rubber sheet S is extruded at a predetermined extruding amount from the mouth piece 21.

The gear pump 20 has a pair of gears 20a, and has a function of discharging the rubber to an outlet side toward the mouth piece 21. The pair of gears 20a is rotatably driven respectively by gear motors 20b, and the rotating speeds thereof are controlled by the controller 5. It is possible to control an extruding amount of the rubber sheet S extruded out of the mouth piece 21 by controlling the rotating speed of the gear motor 20b and the rotating speed of the screw motor 2d by the controller 5 in an interlocking manner. As a matter of illustration, the pair of gears 20a are lined up in a vertical direction in FIG. 2, but maybe actually lined up in a plane direction (a direction in which the rotation axis of the gear 20a is vertical in FIG. 2).

A first pressure sensor 22 is provided on an inlet side of the gear pump 20, that is, a side which is close to the extruding machine 2, and is configured to detect the pressure of the rubber which is supplied from the extruding machine 2. Further, a second pressure sensor 23 is provided on an outlet side of the gear pump 20, and is configured to detect the pressure of the rubber sheet S which is extruded out of the mouth piece 21.

The pressure on the inlet side of the gear pump 20 is determined depending on a rubber feed amount by the gear 20a of the gear pump 20 and the screw 2c of the extruding machine 2. The gear pump 20 can supply the fixed amount of rubber to the mouth piece 21 by keeping the pressure on the inlet side constant, and the extruding amount from the mouth piece 21 is stabilized. However, if the pressure on the inlet side is unstable, the extruding amount from the mouth piece 21 is varied, and thus it becomes difficult to mold the rubber sheet S having a desired dimension.

As a method of controlling the pressure on the inlet side of the gear pump 20, there has been known a PID control of the rotating speed of the gear 20a of the gear pump 20 and the rotating speed of the screw 2c of the extruding machine 2. The PID control is used generally when the rubber is continuously extruded at a fixed amount.

The controller 5 controls the rotating speed of the screw motor 2d of the extruding machine 2 on the basis of the pressure on the inlet side of the gear pump 20 which is detected by the first pressure sensor 22. The controller 5 controls the rotating speed of the gear motor 20b on the basis of a control program which is previously defined (according to a time factor).

In the present embodiment, there is described an example employing a so-called external gear pump in which the gear pump 20 is connected to the leading end side in the extruding direction of the extruding machine 2. However, in place of this, it is possible to employ a gear pump built-in type extruding machine in which the gear pump is build in the extruding machine. In the present invention, the gear pump built-in type extruding machine can easily control the extruding amount in comparison with the extruding machine to which the external gear pump is connected. Since the gear pump built-in type extruding machine does not require any gear motor, the leading end portion of the extruding machine is compact. Thus, the gear pump built-in type extruding machine is more preferable.

The extruding machine 2, the gear pump 20 and the mouth piece 21 are structured such as to be integrally movable back and forth in the extruding direction by a forward and backward drive unit 24, and can move close to and away from the rotary drum 3. The forward and backward movement can be controlled by the controller 5.

The rotary drum 3 is structured such as to be rotatable in a direction of R1 by a servo motor 30. The rotating speed of the servo motor 30 is controlled by the controller 5. The rubber sheet S extruded via the mouth piece 21 is supplied to the outer peripheral surface of the rotary drum 3, and the rubber sheet S can be wound along a peripheral direction by rotationally driving the rotary drum 3 in the direction of R1 in a state where the rubber sheet S is attached to the rotary drum 3. The outer peripheral surface of the rotary drum 3 is made of a metal. The outer diameter of the rotary drum 3 according to the present embodiment is, for example, between 200 and 400 mm.

The rotary drum 3 is preferably provided with a cooling mechanism for cooling the outer peripheral surface. As the cooling mechanism, for example, a water cooling mechanism for circulating a cooling water inside the rotary drum 3 is employed. Further, the outer peripheral surface of the rotary drum 3 may be surface-treated or employ a material so that the attached rubber sheet S can be easily peeled off.

The wrapping device 4 supports the bead core 8 in such a manner that an outer peripheral surface of the rotary drum 3 and an outer surface of the bead core 8 come close to each other at a position which is closer to a downstream side in the rotating direction R1 of the rotary drum 3 than the extruding machine 2, and rotates the supported bead core 8. In the present embodiment, a position where the leading end of the mouth piece 21 of the extruding machine 2 and the outer peripheral surface of the rotary drum 3 come closest to each other is deviated at 180 degrees in the rotating direction R1 of the rotary drum 3 from a position where the inner peripheral surface of the bead core 8 and the outer peripheral surface of the rotary drum 3 come closest to each other. Further, in the present embodiment, the outer diameter of the rotary drum 3 is smaller than the inner diameter of the bead core 8, and the rotary drum 3 is arranged on an inner peripheral side of the bead core 8 which is supported by the wrapping device 4.

The wrapping device 4 is provided for wrapping the rubber sheet S attached to the outer surface of the bead core 8 along the cross-sectional shape of the bead core 8. The wrapping device 4 can rotate the supported bead core 8 in a direction of R2. The bead core 8 rotates in a driven manner on the basis of the rotation of the rotary drum 3.

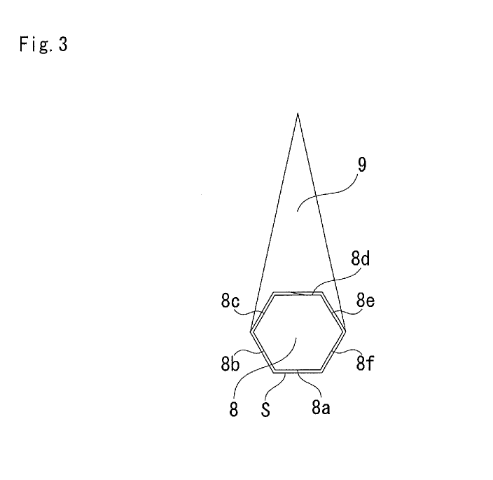

FIG. 3 is a cross-sectional view of the bead core 8. The bead core 8 according to the present embodiment is formed into a hexagonal cross-sectional shape. An inner peripheral surface of the bead core 8 is provided as a lower surface 8a, an outer peripheral surface is provided as an upper surface 8d, side surfaces on the inner peripheral side are provided as lower side surfaces 8b and 8f, and side surfaces on the outer peripheral side are provided as upper side surfaces 8c and 8e. The rubber sheet S is wrapped around a surface of the bead core 8. Further, a bead filler 9 having an approximately triangle shape in its cross section is arranged on the outer peripheral side of the bead core 8. The inner diameter of the bead core 8 according to the present embodiment is, for example, between 400 and 650 mm.

The wrapping device 4 is provided with a retaining roller 41, a first shaping roller 42, a lower side surface pressing roller 43, a second shaping roller 44, a first upper side surface pressing roller 45, a first bending roller 46, a second upper side surface pressing roller 47, a second bending roller 48 and a finishing roller 49 in this order from an upstream side toward a downstream side in the rotating direction R2 of the bead core 8. Further, the wrapping device 4 is provided with a plurality of guide rollers 40 which prevent meandering of the rotating bead core 8.

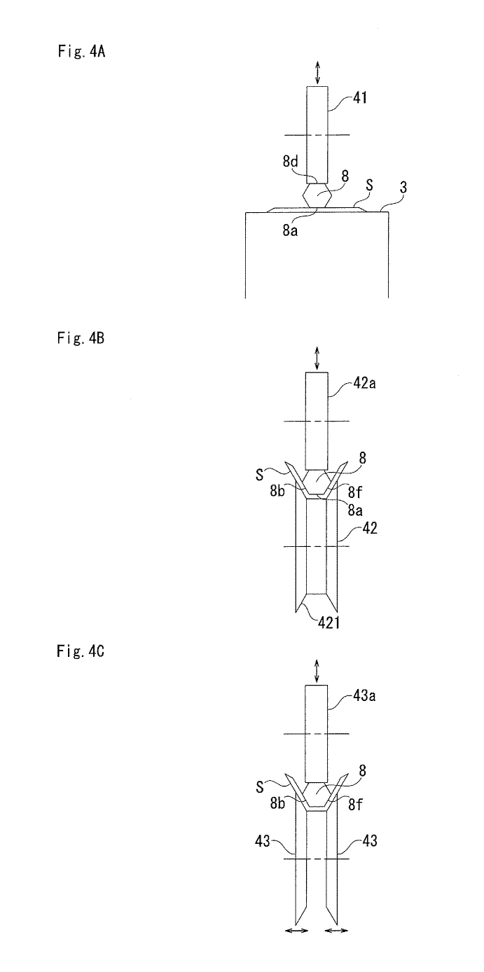

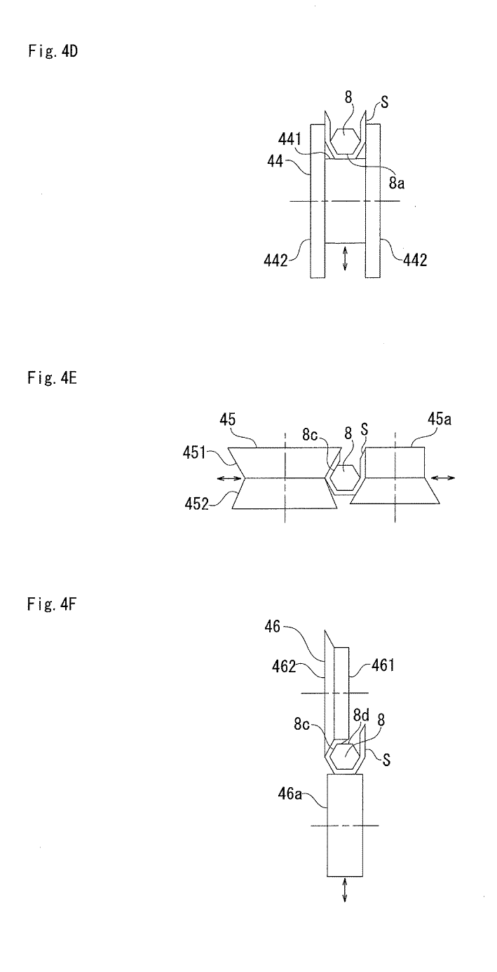

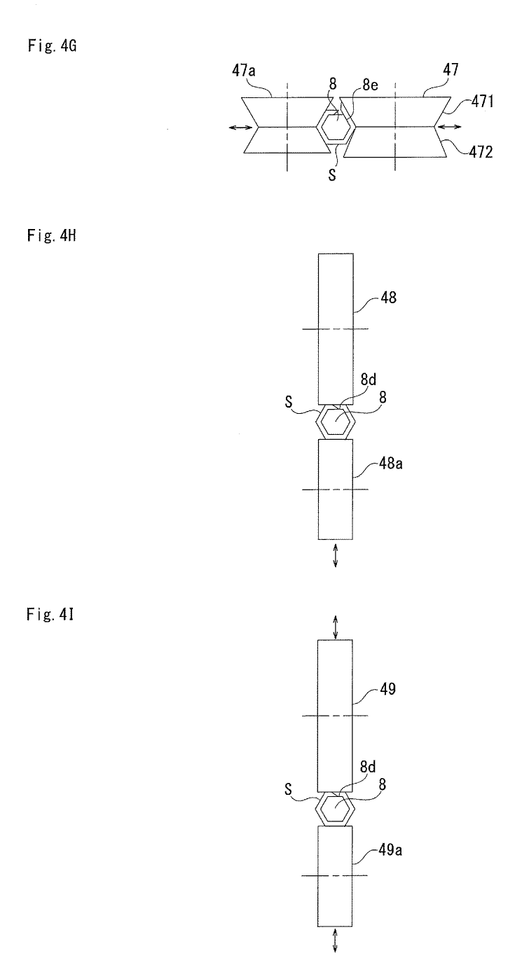

FIG. 4A is a cross-sectional view along a line A-A in FIG. 1. The rubber sheet S is wound around the outer peripheral surface of the rotary drum 3. The cross section of the rubber sheet S according to the present embodiment is thin at both end portions in a width direction, and prevents a joint portion from being thick by overlapping the thin portions when the rubber sheet S is wrapped around the surface of the bead core 8 and is bonded at both end portions in the width direction.

The retaining roller 41 is arranged at a position which is faced to the rotary drum 3 with a part of the bead core 8 interposed therebetween. The axis of rotation of the retaining roller 41 is parallel to the axes of rotation of the rotary drum 3 and the bead core 8, and the retaining roller 41 rotates while an outer peripheral surface of the retaining roller 41 is in contact with the upper surface 8d of the bead core 8. Further, the retaining roller 41 is structured such as to be movable inward and outward in a diametrical direction of the bead core 8. As a result, when a part in a width direction of the rubber sheet S on the outer peripheral surface of the rotary drum 3 is attached to the lower surface 8a of the rotating bead core 8, the retaining roller 41 can press the upper surface 8d of the bead core 8. The retaining roller 41 is a driven roller which rotates in a driven manner on the basis of the rotation of the bead core 8.

FIG. 4B is a cross-sectional view along a line B-B in FIG. 1. The first shaping roller 42 is arranged on an inner peripheral side of the bead core 8. The axis of rotation of the first shaping roller 42 is parallel to the axis of rotation of the bead core 8. The first shaping roller 42 is formed into a spool shape which is recessed at the center from right and left sides, as shown in FIG. 4B. A recessed portion 421 of the first shaping roller 42 is arranged in such a manner as to be in contact with the lower surface 8a and the right and left lower side surfaces 8b and 8f via the rubber sheet S. Further, an auxiliary roller 42a structured such as to be movable inward and outward in the diametrical direction of the bead core 8 is arranged at a position which is faced to the first shaping roller 42 with the bead core 8 interposed therebetween. The axis of rotation of the auxiliary roller 42a is parallel to the axes of rotation of the first shaping roller 42 and the bead core 8. As a result, the rubber sheet S can be folded back upward along the right and left lower side surfaces 8b and 8f of the bead core 8 by the recessed portion 421 of the first shaping roller 42. The first shaping roller 42 and the auxiliary roller 42a are driven rollers which rotate in a driven manner on the basis of the rotation of the bead core 8.

FIG. 4C is a cross-sectional view along a line C-C in FIG. 1. The lower side surface pressing roller 43 is arranged on an inner peripheral side of the bead core 8. The axis of rotation of the lower side surface pressing roller 43 is parallel to the axis of rotation of the bead core 8. The lower side surface pressing roller 43 is provided one by one so as to be faced to the right and left sides of the bead core 8. A pair of lower side surface pressing rollers 43 is structured such as to be movable right and left in the width direction of the bead core 8. The lower side surface pressing roller 43 is formed into a truncated cone shape, and is positioned such that its outer peripheral surfaces formed into taper surfaces are respectively brought into contact with the lower side surfaces 8b and 8f of the bead core 8 via the rubber sheet S. Further, the auxiliary roller 43a structured such as to be movable inward and outward in the diametrical direction of the bead core 8 is arranged at a position which is faced to the lower side surface pressing roller 43 with the bead core 8 interposed therebetween. The axis of rotation of the auxiliary roller 43a is parallel to the axes of rotation of the pressing roller 43 and the bead core 8. As a result, the rubber sheet S can be pressed to the lower side surfaces 8b and 8f of the bead core 8 by the lower side surface pressing roller 43. The lower side surface pressing roller 43 is a drive roller which is driven by a motor (not shown), and the auxiliary roller 43a is a driven roller which rotates in a driven manner on the basis of the rotation of the bead core 8.

FIG. 4D is a cross-sectional view along a line D-D in FIG. 1. The second shaping roller 44 is arranged on an inner peripheral side of the bead core 8. The axis of rotation of the second shaping roller 44 is parallel to the axis of rotation of the bead core 8. The second shaping roller 44 is provided with a body portion 441 which rotates along the lower surface 8a of the bead core 8, and discoid flange portions 442 which are respectively provided on both ends of the body portion 441. An interval between the right and left flange portions 442 is approximately the same as the width obtained by adding the thickness of the rubber sheet S to the width of the bead core 8. Further, the second shaping roller 44 is structured such as to be movable inward and outward in the diametrical direction of the bead core 8. As a result, both end portions in the width direction of the rubber sheet S can be stood upward by the flange portions 442 of the second shaping roller 44 . The second shaping roller 44 is a driven roller which rotates in a driven manner on the basis of the rotation of the bead core 8.

FIG. 4E is a cross-sectional view along a line E-E in FIG. 1. The first upper side surface pressing roller 45 is arranged in a lateral direction of the bead core 8. The axis of rotation of the first upper side surface pressing roller 45 is parallel to the diametrical direction of the bead core 8. The first upper side surface pressing roller 45 is formed into a spool shape obtained by connecting two truncated cone portions 451 and 452. An outer peripheral surface of one truncated cone portion 451 is arranged so as to come into contact with the upper side surface 8c of the bead core 8 via the rubber sheet S. The first upper side surface pressing roller 45 is structured such as to be movable right and left in the width direction of the bead core 8. Further, an auxiliary roller 45a structured such as to be movable right and left in the width direction of the bead core 8 is arranged at a position which is faced to the first upper side surface pressing roller 45 with the bead core 8 interposed therebetween. The axis of rotation of the auxiliary roller 45a is parallel to the axis of rotation of the first upper side surface pressing roller 45. As a result, the rubber sheet S can be pressed to the upper side surface 8c of the bead core 8 by the one truncated cone portion 451 of the first upper side surface pressing roller 45. The first upper side surface pressing roller 45 is a drive roller which is driven by a motor (not shown), and the auxiliary roller 45a is a driven roller which rotates in a driven manner on the basis of the rotation of the bead core 8.

FIG. 4F is a cross-sectional view along a line F-F in FIG. 1. The first bending roller 46 is arranged on the outer peripheral side of the bead core 8. The axis of rotation of the first bending roller 46 is parallel to the axis of rotation of the bead core 8. The first bending roller 46 is provided with a cylindrical portion 461 which rotates along the upper surface 8d of the bead core 8, and a truncated cone portion 462 which is provided at one end of the cylindrical portion 461. An outer peripheral surface of the truncated cone portion 462 is arranged so as to come into contact with the upper side surface 8c of the bead core 8 via the rubber sheet S. An auxiliary roller 46a structured such as to be movable inward and outward in the diametrical direction of the bead core 8 is arranged at a position which is faced to the cylindrical portion 461 of the first bending roller 46 with the bead core 8 interposed therebetween. The axis of rotation of the auxiliary roller 46a is parallel to the axes of rotation of the first bending roller 46 and the bead core 8. As a result, the one end portion of the rubber sheet S can be bent along the upper surface 8d of the bead core 8 by the cylindrical portion 461 of the first bending roller 46. The first bending roller 46 is a drive roller which is driven by a motor (not shown), and the auxiliary roller 46a is a driven roller which rotates in a driven manner on the basis of the rotation of the bead core 8.

FIG. 4G is a cross-sectional view along a line G-G in FIG. 1. The second upper side surface pressing roller 47 is arranged in a lateral direction of the bead core 8. An axis of rotation of the second upper side surface pressing roller 47 is parallel to the diametrical direction of the bead core 8. The second upper side surface pressing roller 47 is formed into a spool shape obtained by connecting two truncated cone portions 471 and 472. An outer peripheral surface of one truncated cone portion 471 is arranged so as to come into contact with the upper side surface 8e of the bead core 8 via the rubber sheet S. The second upper side surface pressing roller 47 is structured such as to be movable right and left in the width direction of the bead core 8. Further, an auxiliary roller 47a structured such as to be movable right and left in the width direction of the bead core 8 is arranged at a position which is faced to the second upper side surface pressing roller 47 with the bead core 8 interposed therebetween. The axis of rotation of the auxiliary roller 47a is parallel to the axis of rotation of the second upper side surface pressing roller 47. As a result, the rubber sheet S can be pressed to the upper side surface 8e of the bead core 8 by the one truncated cone portion 471 of the second upper side surface pressing roller 47. The second upper side surface pressing roller 47 is a drive roller which is driven by a motor (not shown), and the auxiliary roller 47a is a driven roller which rotates in a driven manner on the basis of the rotation of the bead core 8.

FIG. 4H is a cross-sectional view along a line H-H in FIG. 1. The second bending roller 48 is arranged on the outer peripheral side of the bead core 8. The axis of rotation of the second bending roller 48 is parallel to the axis of rotation of the bead core 8. The second bending roller 48 rotates along the upper surface 8d of the bead core 8. Further, an auxiliary roller 48a structured such as to be movable inward and outward in the diametrical direction of the bead core 8 is arranged at a position which is faced to the second bending roller 48 with the bead core 8 interposed therebetween. The axis of rotation of the auxiliary roller 48a is parallel to the axes of rotation of the second bending roller 48 and the bead core 8. As a result, the other end portion of the rubber sheet S can be bent along the upper surface 8d of the bead core 8 by the second bending roller 48. The second bending roller 48 is a drive roller which is driven by a motor (not shown), and the auxiliary roller 48a is a driven roller which rotates in a driven manner on the basis of the rotation of the bead core 8.

FIG. 4I is a cross-sectional view along a line I-I in FIG. 1. The finishing roller 49 is arranged on the outer peripheral side of the bead core 8. The axis of rotation of the finishing roller 49 is parallel to the axis of rotation of the bead core 8. The finishing roller 49 rotates along the upper surface 8d of the bead core 8. The finishing roller 49 is structured such as to be movable inward and outward in the diametrical direction of the bead core 8. Further, an auxiliary roller 49a structured such as to be movable inward and outward in the diametrical direction of the bead core 8 is arranged at a position which is faced to the finishing roller 49 with the bead core 8 interposed therebetween. The axis of rotation of the auxiliary roller 49a is parallel to the axes of rotation of the finishing roller 49 and the bead core 8. As a result, both end portions of the rubber sheet S can be pressed to the upper surface 8d of the bead core 8 by the finishing roller 49. The finishing roller 49 is a drive roller which is driven by a motor (not shown), and the auxiliary roller 49a is a driven roller which rotates in a driven manner on the basis of the rotation of the bead core 8. Further, the finishing roller 49 and the auxiliary roller 49a may be provided with a temperature adjustment mechanism that warms up the roller itself for enhancing the pressing force. As the temperature adjustment mechanism, a temperature adjustment mechanism employing a warm water, a heater or gas can be exemplified.

Next, a description will be given of a bead core covering method using the bead core covering device 1 mentioned above. The bead core covering method according to the present invention includes a step of winding the rubber sheet S extruded out of the extruding machine 2 via the mouth piece 21 around the outer peripheral surface of the rotary drum 3 from the leading end portion, a step of attaching a part in the width direction of the rubber sheet S on the outer peripheral surface of the rotary drum 3 to the outer surface of the rotating bead core 8 from the leading end portion before the rubber sheet S is wound over the entire periphery of the outer peripheral surface of the rotary drum 3, and a step of wrapping the remaining portion in the width direction of the rubber sheet S attached to the outer surface of the bead core 8 along the cross-sectional shape of the bead core 8.

First of all, the bead core 8 is set to the wrapping device 4. At this time, the extruding machine 2 is arranged outside the wrapping device 4.

Next, the extruding machine 2 is moved forward in a direction toward the rotary drum 3, and the mouth piece 21 is brought close to the outer peripheral surface of the rotary drum 3.

Next, the extrusion of the rubber sheet S from the mouth piece 21 of the extruding machine 2 is started, and the rotation of the rotary drum 3 is simultaneously started. In such a manner, the extruded rubber sheet S can be wound around the outer peripheral surface of the rotary drum 3 from the leading end portion.

Then, the center portion in the width direction of the rubber sheet S wound around the outer peripheral surface of the rotary drum 3 is attached to the lower surface 8a of the rotating bead core 8 from the leading end portion (refer to FIG. 4A).

Subsequently, in the rubber sheet S attached to the lower surface 8a of the bead core 8, both end portions in the width direction of the rubber sheet S are wrapped along the cross-sectional shape of the bead core 8 by the wrapping device 4 (refer to FIGS. 4B to 4I). Finally, the extruding machine 2 is moved rearward, and the bead core 8 covered with the rubber sheet S is detached from the wrapping device 4.

Further, in the bead core covering method according to the present invention, the step of winding the rubber sheet S extruded out by the extruding machine 2 via the mouth piece 21 around the outer peripheral surface of the rotary drum 3 from the leading end portion preferably includes: a preparation step of moving the mouth piece 21 close to the rotary drum 3; a winding start step of forming a winding start portion having a wedge cross-sectional shape by starting the rotation of the rotary drum 3 at the same time of starting the extrusion of the rubber from the moved mouth piece 21, gradually increasing an extruding amount of the rubber to a predetermined amount, and gradually enlarging a distance of the mouth piece 21 from the rotary drum 3 to a predetermined distance corresponding to a desired thickness of the rubber sheet S; a winding step of winding the rubber sheet S by maintaining the extruding amount of the rubber at a predetermined amount and maintaining the distance of the mouthpiece 21 from the rotary drum 3 at a predetermined distance; and a winding end step of forming a winding end portion having a wedge cross-sectional shape by gradually reducing the extruding amount of the rubber from the predetermined amount and gradually reducing the distance of the mouth piece 21 from the rotary drum 3 from the predetermined distance.

In the case that the rubber extruded out by the extruding machine 2 is wound around the rotary drum 3, when the extruded rubber passes through a gap between the mouth piece 21 and the outer peripheral surface of the rotary drum 3 so as to rub on the gap, the passing rubber comes to the thickness of the gap.

More specifically, in the winding start step, it is possible to form the winding start portion having the wedge cross-sectional shape and having the thickness gradually increased to the desired thickness of the rubber sheet S while keeping the width constant, by gradually increasing the extruding amount of the rubber to the predetermined amount, and gradually enlarging the distance of the mouth piece 21 from the rotary drum 3 to the predetermined distance. Further, in the winding step, it is possible to make the thickness of the wound rubber to the desired thickness while keeping the width constant, by maintaining the extruding amount of the rubber at the predetermined amount and maintaining the distance of the mouth piece 21 from the rotary drum 3 at the predetermined distance. Further, in the winding end step, it is possible to form the winding end portion having the wedge cross-sectional shape and having the thickness gradually reduced while keeping the width constant, by gradually reducing the extruding amount of the rubber from the predetermined amount, and gradually reducing the distance of the mouth piece 21 from the rotary drum 3 from the predetermined distance. It is possible to eliminate a step in a joint portion between the winding start and the winding end by attaching the rubber sheet S to the outer surface of the bead core 8 so as to overlap the winding end portion with the winding start portion. In the manufacturing of a tire, since the step in the joint portion is eliminated by using the forming method of the rubber sheet S, air intrusion is not generated at the vulcanizing time, and the improvement of uniformity can be achieved. In the winding step, the distance of the mouth piece 21 from the rotary drum 3 can be made larger than the desired thickness of the rubber sheet S. As long as the shape of the discharge port of the mouth piece 21 is the same as the desired cross-sectional shape of the rubber sheet S, it is possible to form the rubber sheet S having the desired thickness by maintaining the extruding amount of the rubber at the predetermined amount in the winding step.

### Other Embodiments

(1) In the first embodiment mentioned above, there is described the example that the center portion in the width direction of the rubber sheet S wound around the outer peripheral surface of the rotary drum 3 is attached to the inner peripheral surface (the lower surface 8a) of the rotating bead core 8 from the leading end portion. However, the structure is not limited thereto.

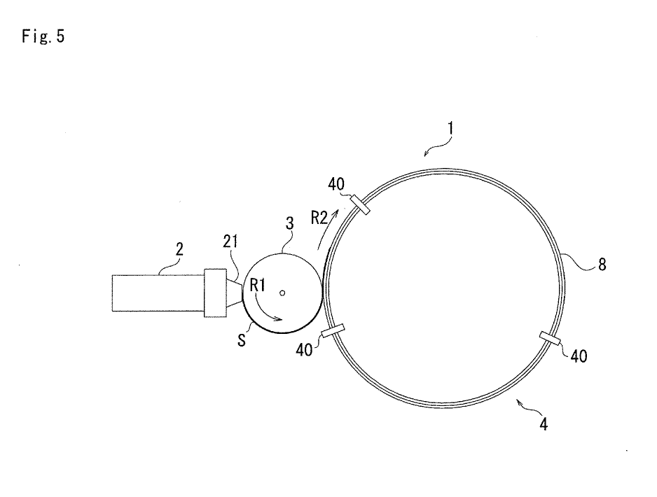

For example, the rotary drum 3 may be arranged on the outer peripheral side of the bead core 8, and the center portion in the width direction of the rubber sheet S wound around the outer peripheral surface of the rotary drum 3 may be attached to the outer peripheral surface of the rotating bead core 8 from the leading end portion, as shown in FIG. 5. According to this structure, a structure of an equipment layout is simple, and it is possible to easily correspond to a size change in the bead core.

Further, the rotary drum 3 may be arranged in the lateral direction of the bead core 8, and the center portion in the width direction of the rubber sheet S wound around the outer peripheral surface of the rotary drum 3 may be attached to the side surface of the rotating bead core 8 from the leading end portion. According to this structure, the structure of the equipment layout is simple and it is possible to easily correspond to the size change in the bead core, similarly to the structure in FIG. 5.

(2) In the first embodiment mentioned above, there is described the example that the position where the leading end of the mouth piece 21 of the extruding machine 2 and the outer peripheral surface of the rotary drum 3 come closest to each other is deviated at 180 degrees in the rotating direction R1 of the rotary drum 3 from the position where the outer peripheral surface of the bead core 8 and the outer peripheral surface of the rotary drum 3 come closest to each other. However, the structure is not limited thereto, and these positions may be deviated at 90 degrees or 270 degrees.

### Second Embodiment

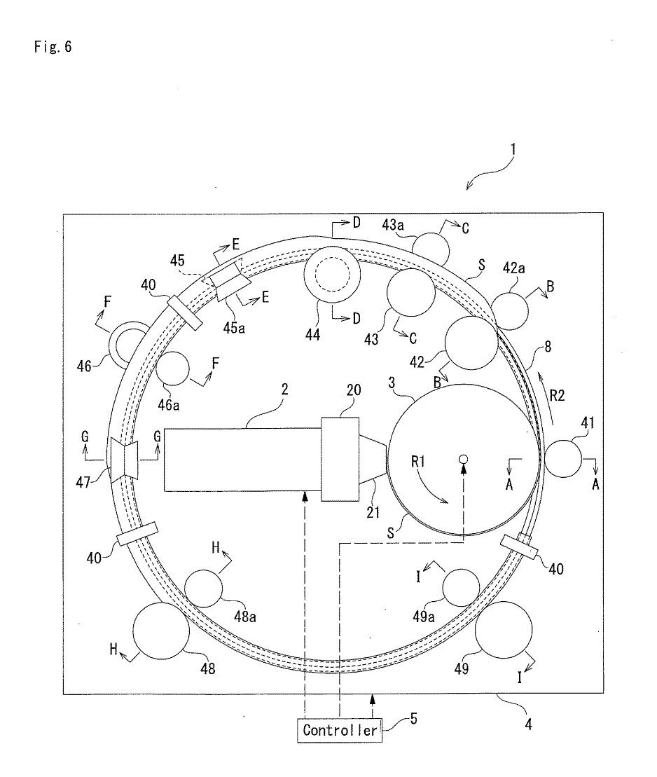

FIG. 6 is a schematic view showing an example of a structure of a bead core covering device 1. The bead core covering device 1 is provided with an extruding machine 2, a rotary drum 3, a wrapping device 4, and a controller 5 which controls the extruding machine 2, the rotary drum 3 and the wrapping device 4.

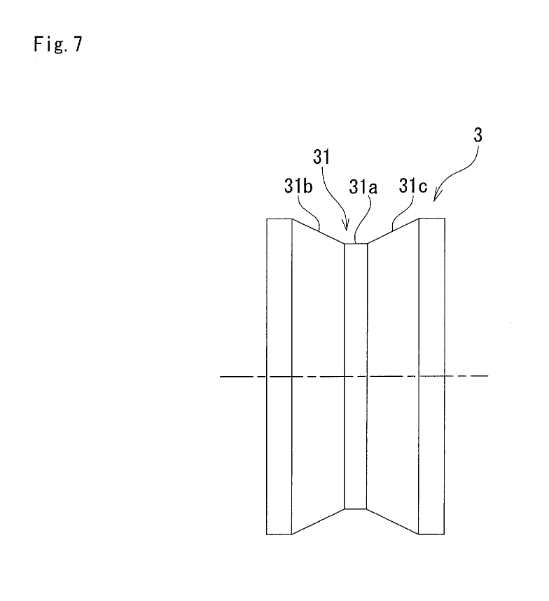

FIG. 7 is a view of the rotary drum 3 as seen from a direction which is perpendicular to the rotation axis. A peripheral groove 31 extending along the peripheral direction is formed in the outer surface of the rotary drum 3. The peripheral groove 31 is formed into an inverse trapezoidal shape in across sectional shape in the axial direction of the rotary drum 3. The peripheral groove 31 is provided with a groove bottom surface 31a, and groove wall surfaces 31b and 31c which extend from both sides of the groove bottom surface 31a.

The wrapping device 4 supports the bead core 8 in such a manner that an outer peripheral surface of the rotary drum 3 and an outer surface of the bead core 8 come close to each other at a position which is closer to a downstream side in the rotating direction R1 of the rotary drum 3 than the extruding machine 2, and rotates the supported bead core 8. In the present embodiment, a position where the leading end of the mouth piece 21 of the extruding machine 2 and the outer peripheral surface of the rotary drum 3 come closest to each other is deviated at 180 degrees in the rotating direction R1 of the rotary drum 3 from a position where the inner peripheral surface of the bead core 8 and the outer peripheral surface of the rotary drum 3 come closest to each other. Further, in the present embodiment, the outer diameter of the rotary drum 3 is smaller than the inner diameter of the bead core 8, and the rotary drum 3 is arranged on an inner peripheral side of the bead core 8 which is supported by the wrapping device 4.

The wrapping device 4 is provided for wrapping up the rubber sheet S attached to the inner peripheral surface of the bead core 8 toward the outer peripheral surface side from the inner peripheral surface side along the cross-sectional shape of the bead core 8. The wrapping device 4 can rotate the supported bead core 8 in a direction of R2. The bead core 8 rotates in a driven manner on the basis of the rotation of the rotary drum 3.

FIG. 3 is a cross-sectional view of the bead core 8. The bead core 8 according to the present embodiment is formed into a hexagonal cross-sectional shape. An inner peripheral surface of the bead core 8 is provided as a lower surface 8a, an outer peripheral surface is provided as an upper surface 8d, side surfaces on the inner peripheral side are provided as lower side surfaces 8b and 8f, and side surfaces on the outer peripheral side are provided as upper side surfaces 8c and 8e. The rubber sheet S is wrapped around a surface of the bead core 8. Further, a bead filler 9 having an approximately triangle shape in its cross section is arranged on the outer peripheral side of the bead core 8. The inner diameter of the bead core 8 according to the present embodiment is, for example, between 400 and 650 mm.

The depth of the peripheral groove 31 of the rotary drum 3 is determined in correspondence to a difference between a diameter of the outer peripheral surface of the bead core 8 and a diameter of the inner peripheral surface thereof. For example, on the assumption that the diameter (the inner diameter) of the inner peripheral surface of the bead core 8 according to the present embodiment is set to 571.5 mm, the diameter (the outer diameter) of the outer peripheral surface is set to 591.5 mm, the diameter of the groove bottom surface 31a of the rotary drum 3 is set to 250 mm, and the groove depth of the peripheral groove 31 is set to α mm, α is set to be equal to or less than 8.75 (≈250×(591.5−571.5/571.5).

The wrapping device 4 is provided with a retaining roller 41, a first shaping roller 42, a lower side surface pressing roller 43, a second shaping roller 44, a first upper side surface pressing roller 45, a first bending roller 46, a second upper side surface pressing roller 47, a second bending roller 48 and a finishing roller 49 in this order from an upstream side toward a downstream side in the rotating direction R2 of the bead core 8. Further, the wrapping device 4 is provided with a plurality of guide rollers 40 which prevent meandering of the rotating bead core 8.

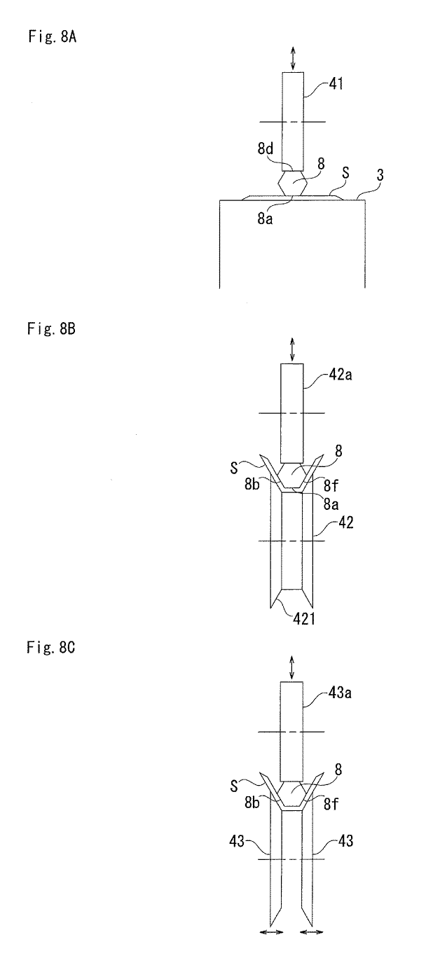

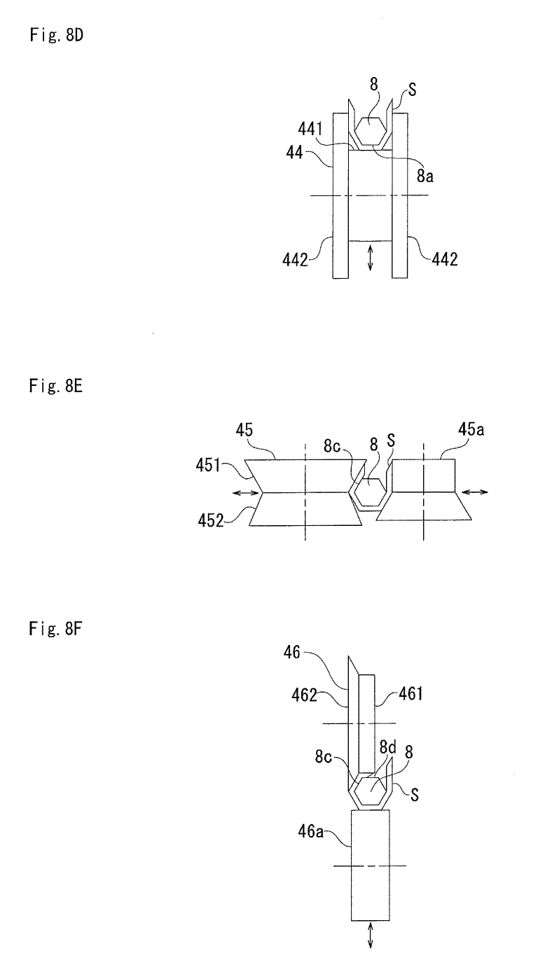

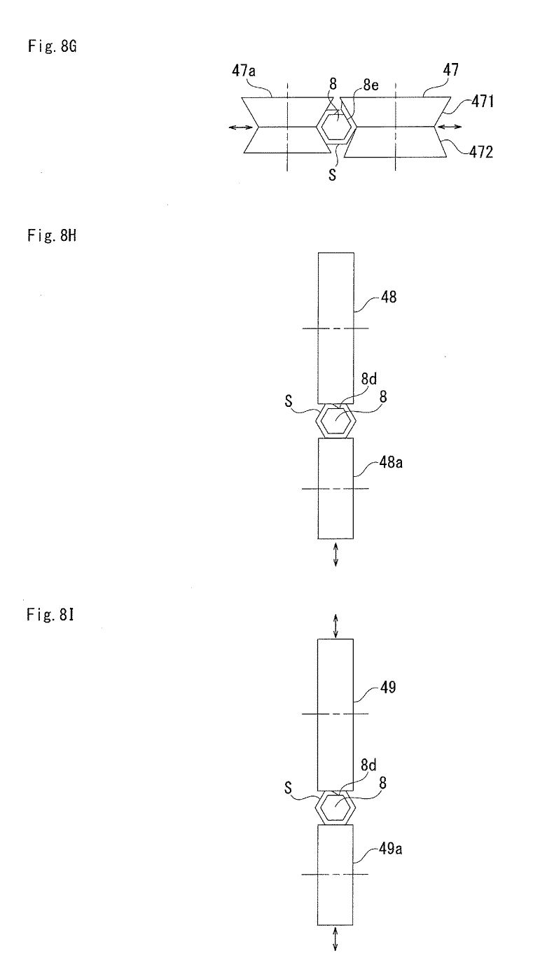

FIG. 8A is a cross-sectional view along a line A-A in FIG. 6. The rubber sheet S is wound around the peripheral groove 31 of the rotary drum 3. The rubber sheet S is wound so as to be attached to the groove bottom surface 31a and the groove wall surfaces 31b and 31c of the peripheral groove 31. The rubber sheet S may be attached to the groove bottom surface 31a and the groove wall surfaces 31b and 31c by using a pressing roller (not shown). The cross-section of the rubber sheet S according to the present embodiment is thinner at both end portions in the width direction. Accordingly, the joint portion is prevented from being thicker by overlapping the thin portions each other when the rubber sheet S is wrapped around the surface of the bead core 8 so as to join both end portions in the width direction.

The retaining roller 41 is arranged at a position which faces to the peripheral groove 31 of the rotary drum 3 while interposing a part of the bead core 8 therebetween. The rotation axis of the retaining roller 41 is parallel to the rotation axes of the rotary drum 3 and the bead core 8, and the retaining roller 41 rotates in a state in which the outer peripheral surface of the retaining roller 41 is in contact with the upper surface 8d of the bead core 8. Further, the retaining roller 41 is structured such as to be movable inward and outward in the diametrical direction of the bead core 8. As a result, the retaining roller 41 can press the upper surface 8d of the bead core 8 when the portion positioned in the groove bottom surface 31a of the peripheral groove 31 in the rubber sheet S on the outer surface of the rotary drum 3 is attached to the lower surface 8a (the inner peripheral surface) of the rotating bead core 8. The retaining roller 41 is a driven roller which rotates in a driven manner on the basis of the rotation of the bead core 8.

FIG. 8B is a cross-sectional view along a line B-B in FIG. 6. The first shaping roller 42 is arranged on an inner peripheral surface side of the bead core 8. The axis of rotation of the first shaping roller 42 is parallel to the axis of rotation of the bead core 8. The first shaping roller 42 is formed into a spool shape which is recessed at the center from right and left sides, as shown in FIG. 8B. A recessed portion 421 of the first shaping roller 42 is arranged in such a manner as to be in contact with the lower surface 8a and the right and left lower side surfaces 8b and 8f via the rubber sheet S. Further, an auxiliary roller 42a structured such as to be movable inward and outward in the diametrical direction of the bead core 8 is arranged at a position which is faced to the first shaping roller 42 with the bead core 8 interposed therebetween. The axis of rotation of the auxiliary roller 42a is parallel to the axes of rotation of the first shaping roller 42 and the bead core 8. As a result, the rubber sheet S can be folded back upward along the right and left lower side surfaces 8b and 8f of the bead core 8 by the recessed portion 421 of the first shaping roller 42. The first shaping roller 42 and the auxiliary roller 42a are driven rollers which rotate in a driven manner on the basis of the rotation of the bead core 8.

FIG. 8C is a cross-sectional view along a line C-C in FIG. 6. The lower side surface pressing roller 43 is arranged on an inner peripheral surface side of the bead core 8. The axis of rotation of the lower side surface pressing roller 43 is parallel to the axis of rotation of the bead core 8. The lower side surface pressing roller 43 is provided one by one so as to be faced to the right and left sides of the bead core 8. A pair of lower side surface pressing rollers 43 is structured such as to be movable right and left in the width direction of the bead core 8. The lower side surface pressing roller 43 is formed into a truncated cone shape, and is positioned such that its outer peripheral surfaces formed into taper surfaces are respectively brought into contact with the lower side surfaces 8b and 8f of the bead core 8 via the rubber sheet S. Further, the auxiliary roller 43a structured such as to be movable inward and outward in the diametrical direction of the bead core 8 is arranged at a position which is faced to the lower side surface pressing roller 43 with the bead core 8 interposed therebetween. The axis of rotation of the auxiliary roller 43a is parallel to the axes of rotation of the pressing roller 43 and the bead core 8. As a result, the rubber sheet S can be pressed to the lower side surfaces 8b and 8f of the bead core 8 by the lower side surface pressing roller 43. The lower side surface pressing roller 43 is a drive roller which is driven by a motor (not shown), and the auxiliary roller 43a is a driven roller which rotates in a driven manner on the basis of the rotation of the bead core 8.

FIG. 8D is a cross-sectional view along a line D-D in FIG. 6. The second shaping roller 44 is arranged on an inner peripheral surface side of the bead core 8. The axis of rotation of the second shaping roller 44 is parallel to the axis of rotation of the bead core 8. The second shaping roller 44 is provided with a body portion 441 which rotates along the lower surface 8a of the bead core 8, and discoid flange portions 442 which are respectively provided on both ends of the body portion 441. An interval between the right and left flange portions 442 is approximately the same as the width obtained by adding the thickness of the rubber sheet S to the width of the bead core 8. Further, the second shaping roller 44 is structured such as to be movable inward and outward in the diametrical direction of the bead core 8. As a result, both end portions in the width direction of the rubber sheet S can be stood upward by the flange portions 442 of the second shaping roller 44. The second shaping roller 44 is a driven roller which rotates in a driven manner on the basis of the rotation of the bead core 8.

FIG. 8E is a cross-sectional view along a line E-E in FIG. 6. The first upper side surface pressing roller 45 is arranged in a lateral direction of the bead core 8. The axis of rotation of the first upper side surface pressing roller 45 is parallel to the diametrical direction of the bead core 8. The first upper side surface pressing roller 45 is formed into a spool shape obtained by connecting two truncated cone portions 451 and 452. An outer peripheral surface of one truncated cone portion 451 is arranged so as to come into contact with the upper side surface 8c of the bead core 8 via the rubber sheet S. The first upper side surface pressing roller 45 is structured such as to be movable right and left in the width direction of the bead core 8. Further, an auxiliary roller 45a structured such as to be movable right and left in the width direction of the bead core 8 is arranged at a position which is faced to the first upper side surface pressing roller 45 with the bead core 8 interposed therebetween. The axis of rotation of the auxiliary roller 45a is parallel to the axis of rotation of the first upper side surface pressing roller 45. As a result, the rubber sheet S can be pressed to the upper side surface 8c of the bead core 8 by the one truncated cone portion 451 of the first upper side surface pressing roller 45. The first upper side surface pressing roller 45 is a drive roller which is driven by a motor (not shown), and the auxiliary roller 45a is a driven roller which rotates in a driven manner on the basis of the rotation of the bead core 8.

FIG. 8F is a cross-sectional view along a line F-F in FIG. 6. The first bending roller 46 is arranged on the outer peripheral surface side of the bead core 8. The axis of rotation of the first bending roller 46 is parallel to the axis of rotation of the bead core 8. The first bending roller 46 is provided with a cylindrical portion 461 which rotates along the upper surface 8d of the bead core 8, and a truncated cone portion 462 which is provided at one end of the cylindrical portion 461. An outer peripheral surface of the truncated cone portion 462 is arranged so as to come into contact with the upper side surface 8c of the bead core 8 via the rubber sheet S. An auxiliary roller 46a structured such as to be movable inward and outward in the diametrical direction of the bead core 8 is arranged at a position which is faced to the cylindrical portion 461 of the first bending roller 46 with the bead core 8 interposed therebetween. The axis of rotation of the auxiliary roller 46a is parallel to the axes of rotation of the first bending roller 46 and the bead core 8. As a result, the one end portion of the rubber sheet S can be bent along the upper surface 8d of the bead core 8 by the cylindrical portion 461 of the first bending roller 46. The first bending roller 46 is a drive roller which is driven by a motor (not shown), and the auxiliary roller 46a is a driven roller which rotates in a driven manner on the basis of the rotation of the bead core 8.

FIG. 8G is a cross-sectional view along a line G-G in FIG. 6. The second upper side surface pressing roller 47 is arranged in a lateral direction of the bead core 8. An axis of rotation of the second upper side surface pressing roller 47 is parallel to the diametrical direction of the bead core 8. The second upper side surface pressing roller 47 is formed into a spool shape obtained by connecting two truncated cone portions 471 and 472. An outer peripheral surface of one truncated cone portion 471 is arranged so as to come into contact with the upper side surface 8e of the bead core 8 via the rubber sheet S. The second upper side surface pressing roller 47 is structured such as to be movable right and left in the width direction of the bead core 8. Further, an auxiliary roller 47a structured such as to be movable right and left in the width direction of the bead core 8 is arranged at a position which is faced to the second upper side surface pressing roller 47 with the bead core 8 interposed therebetween. The axis of rotation of the auxiliary roller 47a is parallel to the axis of rotation of the second upper side surface pressing roller 47. As a result, the rubber sheet S can be pressed to the upper side surface 8e of the bead core 8 by the one truncated cone portion 471 of the second upper side surface pressing roller 47. The second upper side surface pressing roller 47 is a drive roller which is driven by a motor (not shown), and the auxiliary roller 47a is a driven roller which rotates in a driven manner on the basis of the rotation of the bead core 8.

FIG. 8H is a cross-sectional view along a line H-H in FIG. 6. The second bending roller 48 is arranged on the outer peripheral surface side of the bead core 8. The axis of rotation of the second bending roller 48 is parallel to the axis of rotation of the bead core 8. The second bending roller 48 rotates along the upper surface 8d of the bead core 8. Further, an auxiliary roller 48a structured such as to be movable inward and outward in the diametrical direction of the bead core 8 is arranged at a position which is faced to the second bending roller 48 with the bead core 8 interposed therebetween. The axis of rotation of the auxiliary roller 48a is parallel to the axes of rotation of the second bending roller 48 and the bead core 8. As a result, the other end portion of the rubber sheet S can be bent along the upper surface 8d of the bead core 8 by the second bending roller 48. The second bending roller 48 is a drive roller which is driven by a motor (not shown), and the auxiliary roller 48a is a driven roller which rotates in a driven manner on the basis of the rotation of the bead core 8.

FIG. 8I is a cross-sectional view along a line I-I in FIG. 6. The finishing roller 49 is arranged on the outer peripheral side of the bead core 8. The axis of rotation of the finishing roller 49 is parallel to the axis of rotation of the bead core 8. The finishing roller 49 rotates along the upper surface 8d of the bead core 8. The finishing roller 49 is structured such as to be movable inward and outward in the diametrical direction of the bead core 8. Further, an auxiliary roller 49a structured such as to be movable inward and outward in the diametrical direction of the bead core 8 is arranged at a position which is faced to the finishing roller 49 with the bead core 8 interposed therebetween. The axis of rotation of the auxiliary roller 49a is parallel to the axes of rotation of the finishing roller 49 and the bead core 8. As a result, both end portions of the rubber sheet S can be pressed to the upper surface 8d of the bead core 8 by the finishing roller 49. The finishing roller 49 is a drive roller which is driven by a motor (not shown), and the auxiliary roller 49a is a driven roller which rotates in a driven manner on the basis of the rotation of the bead core 8. Further, the finishing roller 49 and the auxiliary roller 49a may be provided with a temperature adjustment mechanism that warms up the roller itself for enhancing the pressing force. As the temperature adjustment mechanism, a temperature adjustment mechanism employing a warm water, a heater or gas can be exemplified.

Next, a description will be given of a bead core covering method using the bead core covering device 1 mentioned above. The bead core covering method according to the present invention includes a step of attaching the leading end portion of the rubber sheet S extruded out of the extruding machine 2 via the mouth piece 21 to the groove bottom surface 31a and the groove wall surfaces 31b and 31c of the peripheral groove 31 which is formed along the peripheral direction on the outer surface of the rotary drum 3 and winding the rubber sheet S around the rotary drum 3, a step of attaching the leading end portion of the portion which is positioned in the groove bottom surface 31a of the peripheral groove 31 in the rubber sheet S on the outer surface of the rotary drum 3 to the inner peripheral surface of the rotating bead core 8 before the rubber sheet S is wound around a whole periphery of the outer surface of the rotary drum 3, and winding the rubber sheet S around the inner peripheral surface of the bead core 8, and a step of wrapping up the remaining portion in the width direction of the rubber sheet S which is attached to the inner peripheral surface of the bead core 8 along the cross-sectional shape of the bead core 8.

First of all, the bead core 8 is set to the wrapping device 4. At this time, the extruding machine 2 is arranged outside the wrapping device 4.

Next, the extruding machine 2 is moved forward in a direction toward the rotary drum 3, and the mouth piece 21 is brought close to the outer surface of the rotary drum 3.

Next, the extrusion of the rubber sheet S from the mouth piece 21 of the extruding machine 2 is started, the leading end portion of the rubber sheet S is attached to the groove bottom surface 31a and the groove wall surfaces 31b and 31c of the peripheral groove 31 which is formed along the peripheral direction in the outer surface of the rotary drum 3, and the rotation of the rotary drum 3 is simultaneously started. As a result, the extruded rubber sheet S can be wound around the groove bottom surface 31a and the groove wall surfaces 31b and 31c of the peripheral groove 31 of the rotary drum 3.

Next, the leading end portion of the portion positioned in the groove bottom surface 31a of the peripheral groove 31 in the rubber sheet S wound onto the outer surface of the rotary drum 3 is attached to the lower surface 8a (the inner peripheral surface) of the rotating bead core 8 (refer to FIG. 8A). As a result, the rubber sheet S can be wound around the inner peripheral surface of the bead core 8.

Next, the rubber sheet S wound around the lower surface 8a of the bead core 8 is wound up to the remaining portion in the width direction of the rubber sheet S by the wrapping device 4, more specifically, the portion wound around the groove wall surfaces 31b and 31c of the peripheral groove 31 is wrapped up along the cross-sectional shape of the bead core 8 (refer to FIGS. 8B to 8I). Finally, the extruding machine 2 is moved rearward and the bead core 8 covered with the rubber sheet S is detached from the wrapping device 4.

Further, the bead core covering method according to the present invention preferably includes: a step of attaching the leading end portion of the rubber sheet S extruded out of the extruding machine 2 via the mouth piece 21 to the groove bottom surface 31a and the groove wall surfaces 31b and 31c of the peripheral groove 31 which is formed along the peripheral direction in the outer surface of the rotary drum 3, and winding the rubber sheet S around the rotary drum 3; a preparation step of moving the mouth piece 21 close to the rotary drum 3; a winding start step of starting the rotation of the rotary drum 3 at the same time of starting the extrusion of the rubber from the close moved mouth piece 21, gradually increasing an extruding amount of the rubber to a predetermined amount, and gradually enlarging a distance of the mouth piece 21 from the rotary drum 3 to a predetermined distance corresponding to a desired thickness of the rubber sheet S, thereby forming a winding start portion having a wedge-shaped cross-sectional shape; a winding step of maintaining the extruding amount of the rubber at the predetermined amount and maintaining the distance of the mouth piece 21 from the rotary drum 3 at the predetermined distance, thereby winding the rubber sheet S; and a winding end step of gradually reducing the extruding amount of the rubber from the predetermined amount and gradually reducing the distance of the mouth piece 21 from the rotary drum 3 from the predetermined distance, thereby forming a winding end portion having a wedge-shaped cross-sectional shape.

In the case that the rubber extruded out of the extruding machine 2 is wound around the rotary drum 3, when the extruded rubber passes through the gap between the mouth piece 21 and the outer surface of the rotary drum 3 so as to be robbed, the passing rubber forms a thickness of the gap. Therefore, the leading end of the mouth piece 21 of the extruding machine 2 is preferably formed so as to be along the cross-sectional shape of the peripheral groove 31. In the present embodiment, the leading end of the mouth piece 21 is preferably formed into a trapezoidal shape.

More specifically, in the winding start step, it is possible to form the winding start portion which has the thickness gradually increased to the desired thickness of the rubber sheet S and has the wedge-shaped cross sectional shape, while keeping the width constant, by gradually increasing the extruding amount of the rubber to the predetermined amount and gradually enlarging the distance of the mouth piece 21 from the rotary drum 3 to the predetermined distance. Further, in the winding step, it is possible to set the wound rubber to the desired thickness while keeping the width constant by maintaining the extruding amount of the rubber at the predetermined mount and maintaining the distance of the mouth piece 21 from the rotary drum 3 at the predetermined distance. Further, in the winding end step, it is possible to form the winding end portion which has the thickness reduced gradually and has the wedge-shaped cross-sectional shape while keeping the width constant by gradually reducing the extruding amount of the rubber from the predetermined amount and gradually reducing the distance of the mouth piece 21 from the rotary drum 3 from the predetermined distance. It is possible to eliminate a step in a joint portion between the winding start and winding end portions by attaching the rubber sheet S to the outer surface of the bead core 8 in such a manner as to wrap the winding end portion over the winding start portion. In the manufacturing of a tire, since the step in the joint portion is eliminated by using the forming method of the rubber sheet S, air intrusion is not generated at the vulcanizing time, and the improvement of uniformity can be achieved.

### Third Embodiment

The second embodiment as above describes the example that the rubber sheet S wound onto the outer surface of the rotary drum 3 is attached to the inner peripheral surface (the lower surface 8a) of the rotating bead core 8 from the leading end portion of the portion which is positioned in the groove bottom surface 31a of the peripheral groove 31. However, the structure is not limited thereto.

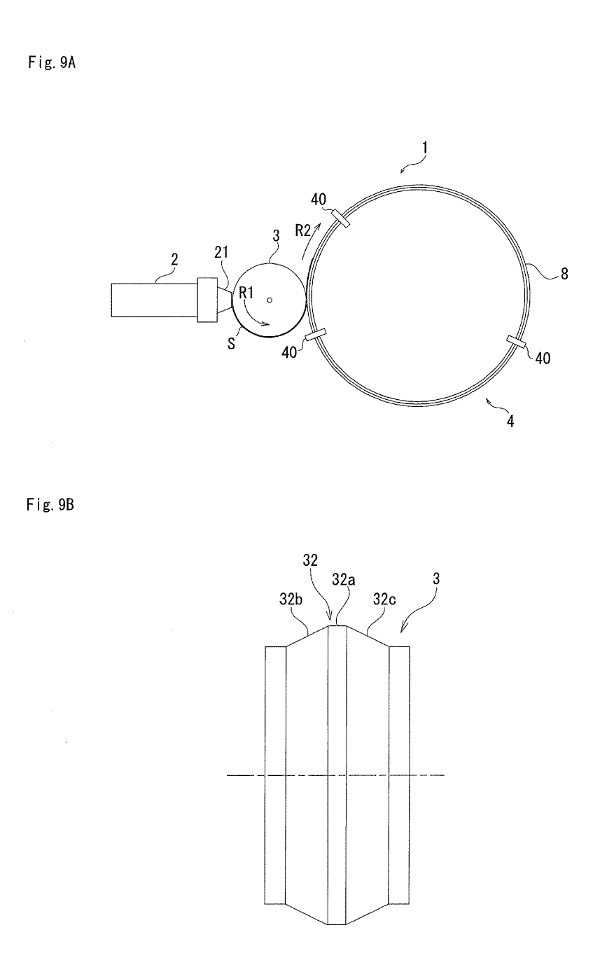

As shown in FIG. 9A, a bead core covering device 1 according to a third embodiment may include: an extruding machine 2 which extrudes the rubber sheet S; a rotary drum 3 around which the rubber sheet S extruded out of the extruding machine 2 is wound; a wrapping device 4 which supports a bead core 8 so that an outer surface of the rotary drum 3 and an outer peripheral surface of the bead core 8 come close to each other at a position on a downstream side in a rotating direction of the rotary drum 3 from the extruding machine 2, and which rotates the supported bead core 8; and a controller which controls the extruding machine 2, the rotary drum 3 and the wrapping device 4. A peripheral projection 32 extending along a peripheral direction is formed in the outer surface of the rotary drum 3 as shown in FIG. 9B. In the bead core covering device 1, the controller attaches a leading end portion of the rubber sheet S extruded out of the extruding machine 2 to a top surface 32a and side surfaces 32b and 32c of the peripheral projection 32 in the rotary drum 3, winds the rubber sheet S around the rotary drum 3, attaches a leading end portion of a portion which is positioned in the top surface 32a of the peripheral projection 32 in the rubber sheet S on the outer surface of the rotary drum 3 to an outer peripheral surface of the rotating bead core 8 before the rubber sheet S is wound around a whole periphery of the outer surface of the rotary drum 3, winds the rubber sheet S around the outer peripheral surface of the bead core 8, and wraps the remaining portion in the width direction of the rubber sheet S wound around the outer peripheral surface of the bead core 8 along the cross-sectional shape of the bead core 8 by the wrapping device 4. According to the bead core covering device 1, a structure of an equipment layout is simple, and it is possible to easily correspond to a size change in the bead core 8. A protruding height of the peripheral projection 32 is preferably determined in correspondence to a difference between a diameter of an outer peripheral surface and a diameter of an inner peripheral surface of the bead core 8. Further, the leading end of the mouth piece 21 of the extruding machine 2 is preferably formed along the cross-sectional shape of the peripheral projection 32.

A bead core covering method according to the third embodiment includes: a step of attaching the leading end portion of the rubber sheet S extruded out of the extruding machine 2 via the mouth piece 21 to the top surface 32a and the side surfaces 32b and 32c of the peripheral projection 32 which is formed along the peripheral direction in the outer surface of the rotary drum 3, and winding the rubber sheet S around the rotary drum 3; a step of attaching the leading end portion of the portion which is positioned in the top surface 32a of the peripheral projection 32 in the rubber sheet S on the outer surface of the rotary drum 3 to the outer peripheral surface of the rotating bead core 8 before the rubber sheet S is wound around a whole periphery of the outer surface of the rotary drum 3, and winding the rubber sheet S around the outer peripheral surface of the bead core 8; and a step of wrapping the remaining portion in the width direction of the rubber sheet S wound around the outer peripheral surface of the bead core 8 along the cross-sectional shape of the bead core 8.

### Other Embodiments

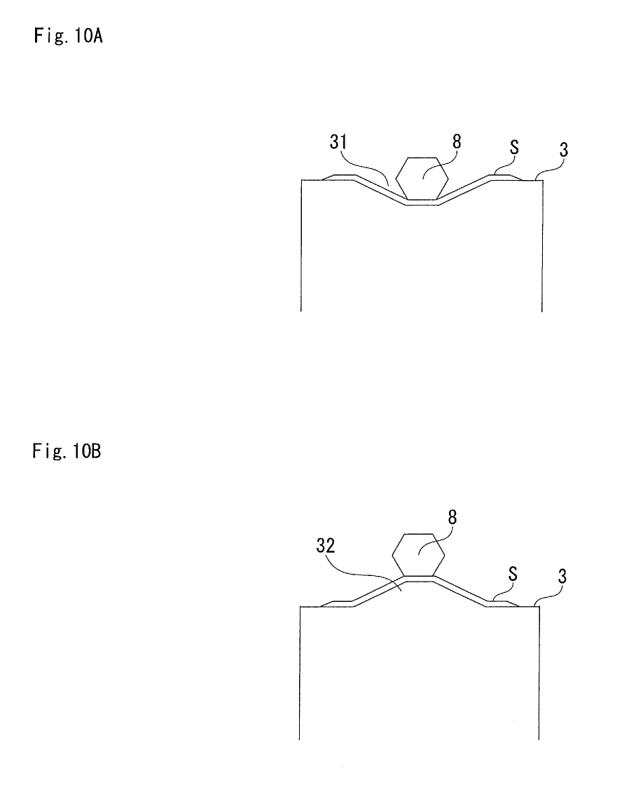

(1) The rubber sheet S wound around the outer surface of the rotary drum 3 is not necessarily attached to the groove bottom surface 31a and the groove wall surfaces 31b and 31c of the peripheral groove 31 as a whole in the width direction. The both ends in the width direction may be attached to the outer surface of the rotary drum 3 over the groove wall surfaces 31b and 31c as shown in FIG. 10A.

In the same manner, the rubber sheet S wound around the outer surface of the rotary drum 3 is not necessarily attached to the top surface 32a and the side surfaces 32b and 32c of the peripheral projection 32 as a whole in the width direction. The both ends in the width direction may be attached to the outer surface of the rotary drum 3 over the side surfaces 32b and 32c as shown in FIG. 10B.

(2) The embodiment as above describes the example that the position where the leading end of the mouth piece 21 of the extruding machine 2 and the outer surface of the rotary drum 3 are the closest is deviated at 180 degrees in the rotating direction R1 of the rotary drum 3 from the position where the outer surface (the inner peripheral surface or the outer peripheral surface) of the bead core 8 and the outer surface of the rotary drum 3 are the closest. However, the structure is not limited thereto, but the positions may be deviated at 90 degrees or 270 degrees.

What is claimed is:

1. A bead core covering method for covering an annular bead core with a belt-like rubber sheet, the method comprising the steps of:
winding the rubber sheet extruded by an extruding machine via a mouth piece around an outer peripheral surface of a rotary drum from a leading end portion;
attaching a part in a width direction of the rubber sheet on the outer peripheral surface of the rotary drum to an outer surface of the bead core, which rotates, from the leading end portion before the rubber sheet is wound over an entire periphery of the outer peripheral surface of the rotary drum; and
wrapping a remaining portion in the width direction of the rubber sheet attached to the outer surface of the bead core along a cross-sectional shape of the bead core.

2. The bead core covering method according to claim 1, wherein, in the step of winding the rubber sheet around the outer peripheral surface of the rotary drum from the leading end portion, a distance from the outer peripheral surface of the rotary drum to the mouth piece is set to be equal to or less than a desired thickness of the rubber sheet.

3. The bead core covering method according to claim 1, wherein, in the step of attaching the part in the width direction of the rubber sheet on the outer peripheral surface of the rotary drum to the outer surface of the bead core, which rotates, from the leading end portion, a retaining roller is arranged at a position which faces to the rotary drum with apart of the bead core interposed between the retaining roller and the rotary drum, and the rubber sheet is attached while pressing the bead core by the retaining roller.

4. A bead core covering device for covering an annular bead core with a belt-like rubber sheet, the device comprising:
an extruding machine which extrudes the rubber sheet;
a rotary drum around which the rubber sheet extruded from the extruding machine is wound;
a wrapping device which supports the bead core at a position closer to a downstream side in a rotating direction of the rotary drum than the extruding machine such that an outer peripheral surface of the rotary drum and an outer surface of the bead core come close to each other, and rotates the supported bead core; and
a controller which controls the extruding machine, the rotary drum and the wrapping device, wherein
the controller winds the rubber sheet extruded out of the extruding machine around the outer peripheral surface of the rotary drum from a leading end portion, attaches a part in a width direction of the rubber sheet on the outer peripheral surface of the rotary drum to the outer surface of the bead core, which rotates, from the leading end portion before the rubber sheet is wound over an entire periphery of the outer peripheral surface of the rotary drum, and wraps a remaining portion in the width direction of the rubber sheet attached to the outer surface of the bead core along a cross-sectional shape of the bead core by the wrapping device.

5. The bead core covering device according to claim 4, wherein an outer diameter of the rotary drum is smaller than an inner diameter of the bead core, and the rotary drum is arranged on an inner peripheral side of the bead core which is supported by the wrapping device.

6. The bead core covering device according to claim 4, wherein the rotary drum is provided with a cooling mechanism which cools the outer peripheral surface.

7. A bead core covering method for covering an annular bead core with a belt-like rubber sheet, the method comprising the steps of:
attaching a leading end portion of the rubber sheet extruded by an extruding machine via a mouth piece to a groove bottom surface and groove wall surfaces of a peripheral groove which is formed along a peripheral direction in an outer surface of a rotary drum, and winding the rubber sheet around the rotary drum;
attaching the leading end portion of a portion which is positioned in the groove bottom surface of the peripheral groove in the rubber sheet on the outer surface of the rotary drum to an inner peripheral surface of the rotating bead core before the rubber sheet is wound around a whole periphery of the outer surface of the rotary drum, and winding the rubber sheet around the inner peripheral surface of the bead core; and
wrapping up a remaining portion in a width direction of the rubber sheet wound around the inner peripheral surface of the bead core along a cross-sectional shape of the bead core.

8. A bead core covering method for covering an annular bead core with a belt-like rubber sheet, the method comprising the steps of:
attaching a leading end portion of the rubber sheet extruded by an extruding machine via a mouth piece to a top surface and side surfaces of a peripheral projection which is formed along a peripheral direction in an outer surface of a rotary drum, and winding the rubber sheet around the rotary drum;
attaching the leading end portion of a portion which is positioned in the top surface of the peripheral projection in the rubber sheet on the outer surface of the rotary drum to an outer peripheral surface of the rotating bead core before the rubber sheet is wound around a whole periphery of the outer surface of the rotary drum, and winding the rubber sheet around the outer peripheral surface of the bead core; and
wrapping up a remaining portion in a width direction of the rubber sheet wound around the outer peripheral surface of the bead core along a cross-sectional shape of the bead core.

9. A bead core covering device for covering an annular bead core with a belt-like rubber sheet, the device comprising:
an extruding machine which extrudes the rubber sheet;
a rotary drum around which the rubber sheet extruded from the extruding machine is wound;
a wrapping device which supports the bead core in such a manner that an outer surface of the rotary drum and an inner peripheral surface of the bead core come close to each other at a position on a downstream side in a rotating direction of the rotary drum from the extruding machine, and which rotates the supported bead core; and
a controller which controls the extruding machine, the rotary drum and the wrapping device, wherein
the outer surface of the rotary drum has a peripheral groove which extends along a peripheral direction,
the controller attaches a leading end portion of the rubber sheet extruded by the extruding machine to a groove bottom surface and groove wall surfaces of the peripheral groove in the rotary drum, and winds the rubber sheet around the rotary drum,
the controller attaches the leading end portion of a portion which is positioned in the groove bottom surface of the peripheral groove in the rubber sheet on the outer surface of the rotary drum to an inner peripheral surface of the rotating bead core before the rubber sheet is wound around a whole periphery of the outer surface of the rotary drum, and winds the rubber sheet around the inner peripheral surface of the bead core, and
the controller wraps up a remaining portion in a width direction of the rubber sheet which is wound around the inner peripheral surface of the bead core along a cross-sectional shape of the bead core by the wrapping device.

10. The bead core covering device according to claim 9, wherein a groove depth of the peripheral groove is determined in correspondence to a difference between a diameter of an outer peripheral surface of the bead core and a diameter of the inner peripheral surface of the bead core.

11. The bead core covering device according to claim 9, wherein a leading end of a mouth piece of the extruding machine is formed along a cross-sectional shape of the peripheral groove.

12. A bead core covering device for covering an annular bead core with a belt-like rubber sheet, the device comprising:
an extruding machine which extrudes the rubber sheet;
a rotary drum around which the rubber sheet extruded from the extruding machine is wound;
a wrapping device which supports the bead core in such a manner that an outer surface of the rotary drum and an outer peripheral surface of the bead core come close to each other at a position on a downstream side in a rotating direction of the rotary drum from the extruding machine, and which rotates the supported bead core; and
a controller which controls the extruding machine, the rotary drum and the wrapping device, wherein
the outer surface of the rotary drum has a peripheral projection which extends along a peripheral direction,
the controller attaches a leading end portion of the rubber sheet extruded by the extruding machine to a top surface and side surfaces of the peripheral projection in the rotary drum, and winds the rubber sheet around the rotary drum,
the controller attaches the leading end portion of a portion which is positioned in the top surface of the peripheral projection in the rubber sheet on the outer surface of the rotary drum to an outer peripheral surface of the rotating bead core before the rubber sheet is wound around a whole periphery of the outer surface of the rotary drum, and winds the rubber sheet around the outer peripheral surface of the bead core, and
the controller wraps up a remaining portion in a width direction of the rubber sheet which is wound around the outer peripheral surface of the bead core along a cross-sectional shape of the bead core by the wrapping device.

13. The bead core covering device according to claim 12, wherein a protruding height of the peripheral projection is determined in correspondence to a difference between a diameter of the outer peripheral surface of the bead core and a diameter of an inner peripheral surface of the bead core.

14. The bead core covering device according to claim 12, wherein a leading end of a mouth piece of the extruding machine is formed along a cross-sectional shape of the peripheral projection.
